(19) United States
(12) Patent Application Publication
(10) Pub. No.: US 2013/0126685 A1
(43) Pub. Date: May 23, 2013

(54) Display Mounting Interface System and Method

(71) Applicants: James R. Lucas, Eagan, MN (US); Patrick L. Plehn, Gilbert, AZ (US)

(72) Inventors: James R. Lucas, Eagan, MN (US); Patrick L. Plehn, Gilbert, AZ (US)

(73) Assignee: ERGOTRON, INC., Eagan, MN (US)

(21) Appl. No.: 13/475,372

(22) Filed: May 18, 2012

Related U.S. Application Data
(60) Provisional application No. 61/487,952, filed on May 19, 2011.

(51) Int. Cl. F16M 13/02

(52) U.S. Cl. CPC F16M 13/02
USPC 248/205.1; 29/525.02

(57) ABSTRACT

An interface system to connect an electronic display to a support. An interface system adapted to allow a user to easily level an electronic display to a desired ergonomic angle regardless of the angle of the support. A method of leveling a display relative to a support.

### RELATED APPLICATIONS

This application claims the benefit of U.S. Provisional Patent Application Ser. No. 61/487,952, filed May 19, 2011, and titled Display Mounting Interface System and Method, the contents of which are hereby incorporated by reference.

### FIELD

The invention generally relates to systems and methods for mounting electronic displays to supports.

### BACKGROUND

Electronic displays are generally connected to a support, such as an arm or stand, via a

Video Electronics Standards Association (VESA) complaint connection. Standard VESA compliant connections typically include a plate with four apertures. Screws are inserted through the apertures and engaged with threaded apertures in the display to attach the plate to the display. The other side of the plate is connected to the support.

Unfortunately, these types of standard connections do not allow for any angular variation from the connection to the display and the connection to the support. Accordingly, in situations where the support is skewed relative to a desired angle, a display attached to the support with such a connection will also be skewed. For example, if an arm is at an angle of 5 degrees from horizontal, a display attached to the arm via such a method will also be at an angle of 5 degrees from horizontal.

### SUMMARY

Embodiments of the invention include an interface system to connect an electronic display to a support, such as an arm or stand. In some embodiments, the interface system is adapted to allow a user to easily level an electronic display to a desired ergonomic angle regardless of the angle of the support. In such embodiments, the interface system allows for angular variation between the display and the support. In some embodiments, the interface system allows for between about 5 degrees and about 10 degrees of rotation relative to a generally horizontal axis extending through the plane of an electronic display. As an example, if an arm is provided at a skewed angle, the interface system can be used to easily connect a display to the arm with the display being held at a level, unskewed angle. In some embodiments, the interface system is configured so that gravity provides the leveling function. Further, some embodiments of the interface system are of a “quick connect” variety, which allow a user to quickly connect a display to a support. Embodiments of the invention also include methods of using such interface systems.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 includes a perspective view of an unengaged display mounting bracket and a support bracket in accordance with an embodiment of the invention.

FIG. 2 includes a perspective view of a partially engaged display mounting bracket and support bracket in accordance with an embodiment of the invention.

FIG. 3 includes a perspective view of a fully engaged display mounting bracket and support bracket in accordance with an embodiment of the invention.

FIG. 4 includes a rear perspective view of a display and a fully engaged display mounting bracket and support bracket in accordance with an embodiment of the invention.

FIG. 5 includes a rear plan view of a fully engaged display mounting bracket and support bracket in accordance with an embodiment of the invention.

FIG. 6 includes a front plan view of a display mounting bracket in accordance with an embodiment of the invention.

FIG. 7 includes a partially exploded perspective view of a display mounting bracket and support bracket in accordance with an embodiment of the invention.

FIG. 8 includes a fully exploded perspective view of a display mounting bracket and support bracket in accordance with an embodiment of the invention.

FIG. 9 includes a rear plan schematic view of a display and display mounting bracket in accordance with an embodiment of the invention.

FIG. 10 includes a diagram of steps of an exemplary method in accordance with an embodiment of the invention.

### DETAILED DESCRIPTION OF THE PREFERRED EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

In some embodiments, the invention includes an interface system to connect an electronic display to a support, such as a stand or arm. The electronic display can be of any type, including LED, LCD, or plasma. Further, the support may be of any type, including, for example, arms, stands, and any of the supports described in U.S. application Ser. Nos. 11/254,225, 12/407,566, 12/614,032, 12/729,811, 12/944,966, 12/945,068, and 61/369,392, the relevant contents of each of which are hereby incorporated by reference.

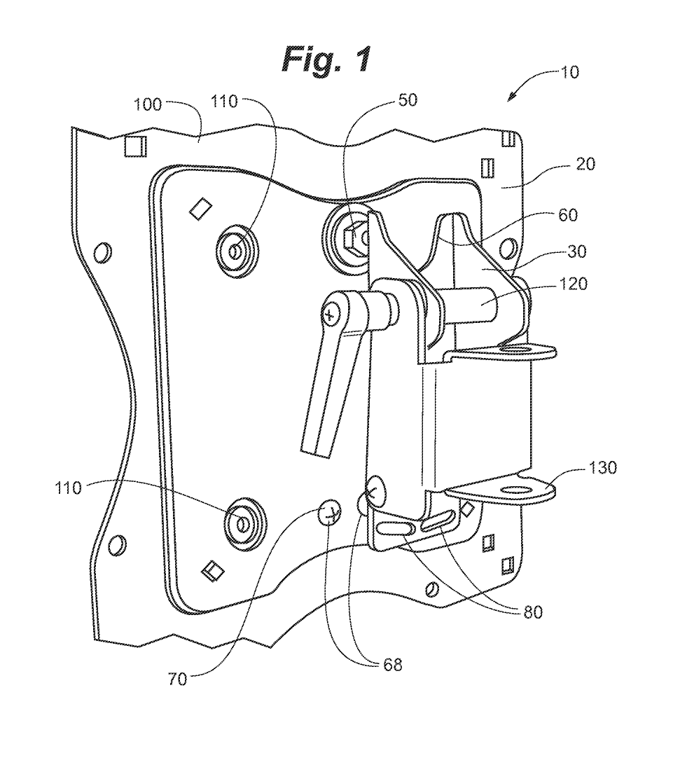

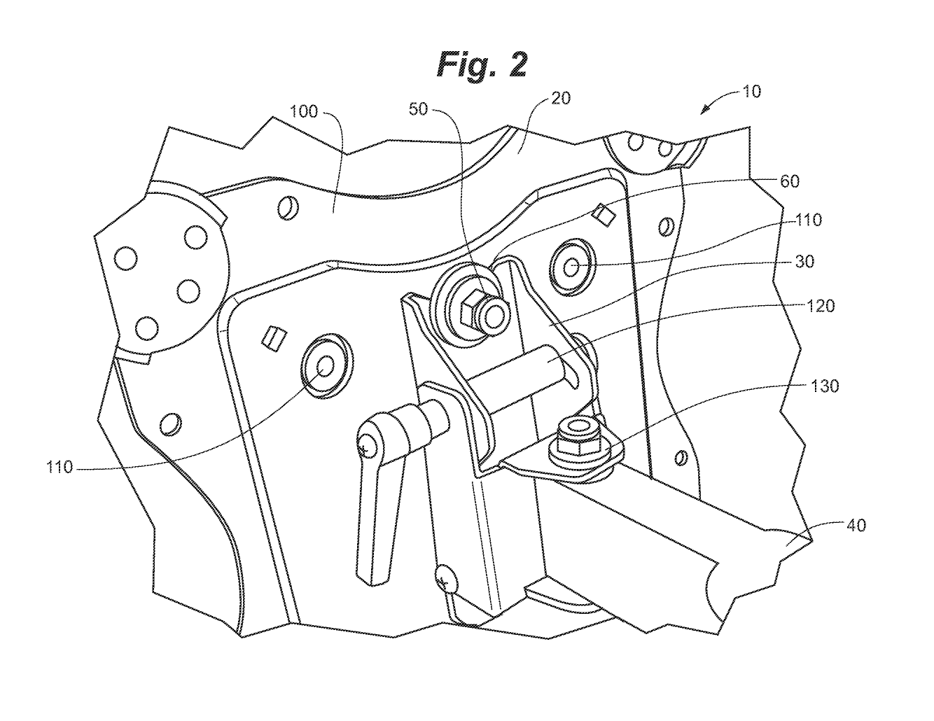

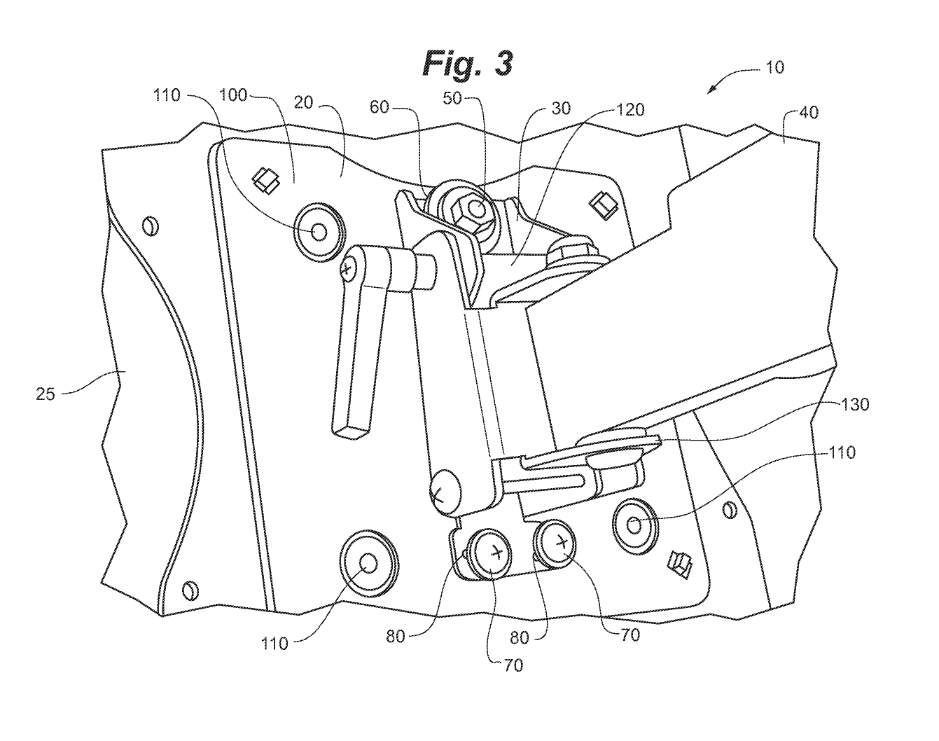

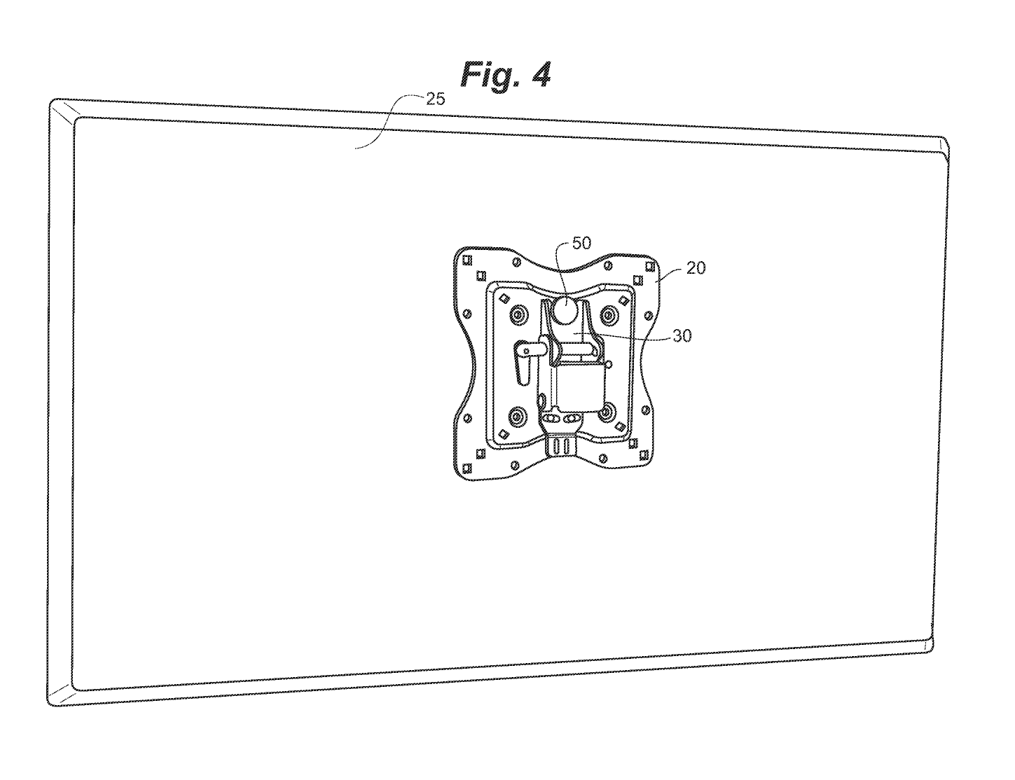

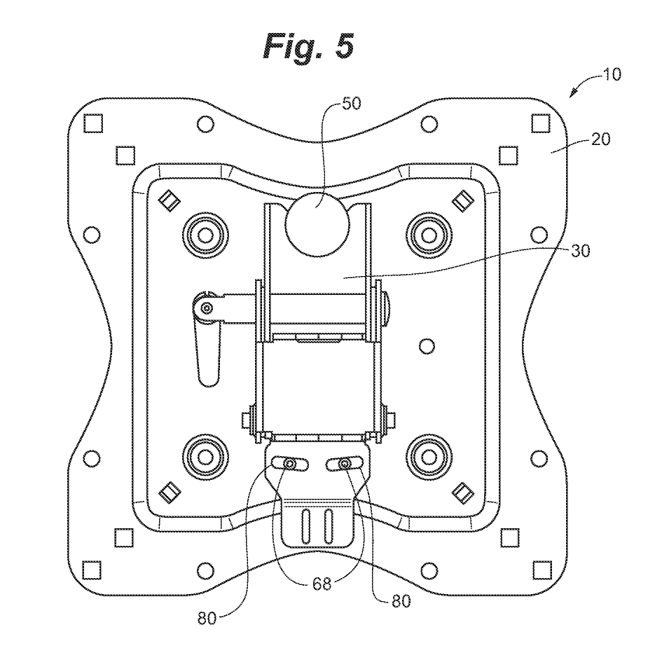

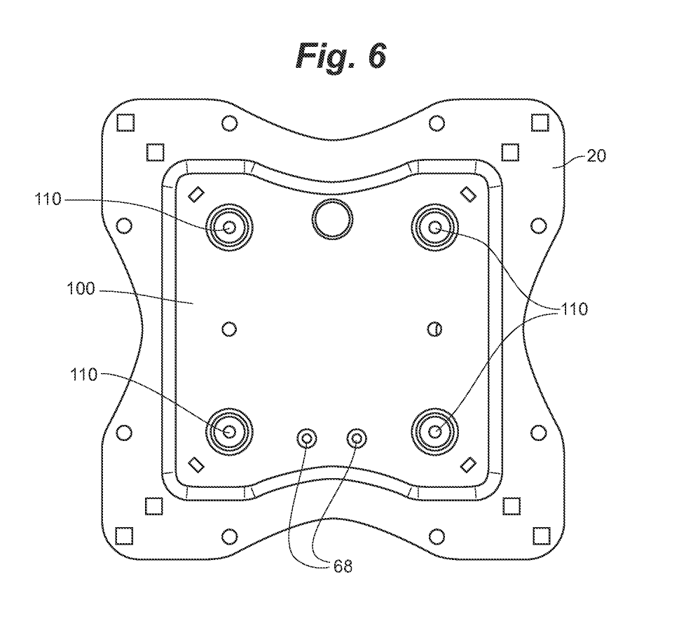

As shown in FIGS. 1-8, embodiments of the interface system 10 include a display mounting bracket 20 for connecting to a display (e.g., a rear of the display 25 as shown in FIGS. 3 and 4), and a support bracket 30 for connecting to a support 40 (as shown in FIGS. 2 and 3), such as an arm or stand. In some embodiments, the interface system is adapted to allow a user to easily level an electronic display to a desired ergonomic angle regardless of the angle of the support. In such embodiments, the interface system allows for angular variation between the display and the support to allow the display to align before the rotational movement is optionally fixed.

In some embodiments, the display mounting bracket 20 includes a projection 50. Projection 50 can include any suitable shape. In some embodiments, it includes a generally cylindrical extending portion extending generally perpendicular from a rear plane of the electronic display, such as a bolt having a generally circular cross-section with a first diameter. In some embodiments, the projection includes an optional lip having a generally circular cross-section with a second diameter, the second diameter being larger than the first diameter.

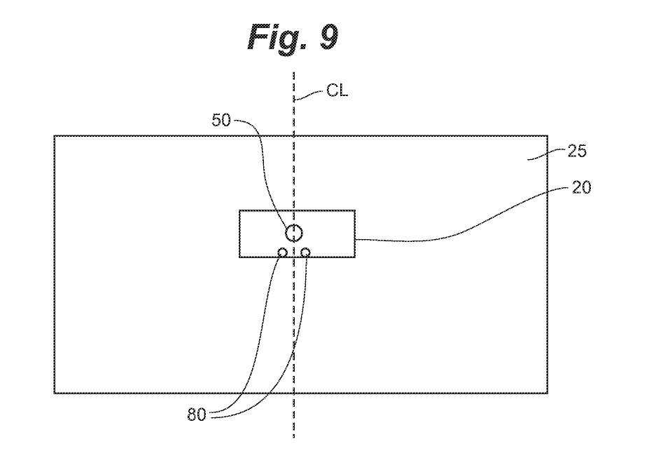

The support bracket 30 may include a groove 60 to receive the projection 50. In such embodiments the groove may include a generally half-circular resection such that the projection can enter the groove and be guided to a resting position in the groove. In such embodiments, the display mounting bracket can be hung on the groove, which allows for rotational movement between the display mounting bracket and the support bracket (e.g., about an axis extending perpendicularly from a plane defined by the display mounting bracket, such as an axis coincident with a longitudinal axis of the projection). Accordingly, a user can angularly position the display at a desired angular orientation with respect to the support, regardless of the angular orientation of the support. In embodiments of a projection having a lip, the lip can engage the support bracket such that the groove is sandwiched between the lip and the display mounting bracket.

[22] In some embodiments, a user can allow the display to self-align. In such embodiments, the interface is configured so that gravity can provide a leveling function. For example the projection 50 can be provided in a generally central position with respect to the display mounting bracket and/or display, so that a display hanging from a groove 60 via the projection 50 will tend to assume a level orientation to balance gravitation forces acting on the display on either side of the projection. Such an embodiment is shown in FIG. 9, which depicts projection 50 and display bracket 20 mounted on a rear of an electronic display 25. In FIG. 9, the display has a centerline CL about which its weight is substantially equal on either side of the centerline CL. As shown, projection 50 substantially intersects centerline CL.

As shown best in FIGS. 1, 6, 7, and 8, in some embodiments of the interface system the display mounting bracket 20 also includes at least one (e.g., two) aperture 68 for receiving a connector 70 (e.g. a screw) (the aperture is shown receiving a connector 70 in FIG. 1). Also as shown, the support bracket includes at least one (e.g., two) slot 80 for receiving the connector 70. In some embodiments, the aperture 68 can be positioned below the projection 50 on the display mounting bracket, and the slot 80 can be positioned below the groove 60 on the support bracket. In such embodiments, the slot 80 allows a connector received within the aperture and through the slot to move relative to the support bracket. When a desired angular orientation is achieved, the connector can be actuated (e.g., tightened) to fix at a desired orientation the relative angular orientation of the display mounting bracket with respect to the support bracket about a generally horizontal axis extending through the rear of the display.

In general, the slot 80 is wider than the aperture 68, and allows relative movement of a few degrees in either direction even when connector 70 is partially engaged with aperture 68. In some embodiments, the interface system allows for between about 5 degrees and about 10 degrees of rotation relative to a generally horizontal axis extending through the rear of the electronic display (i.e., portrait/landscape (“P/L”) rotational adjustment). In certain embodiments, the slots are curved to allow for a constant radius between a center of the slot and the projection regardless of the angular orientation of the display mounting bracket relative to the support bracket.

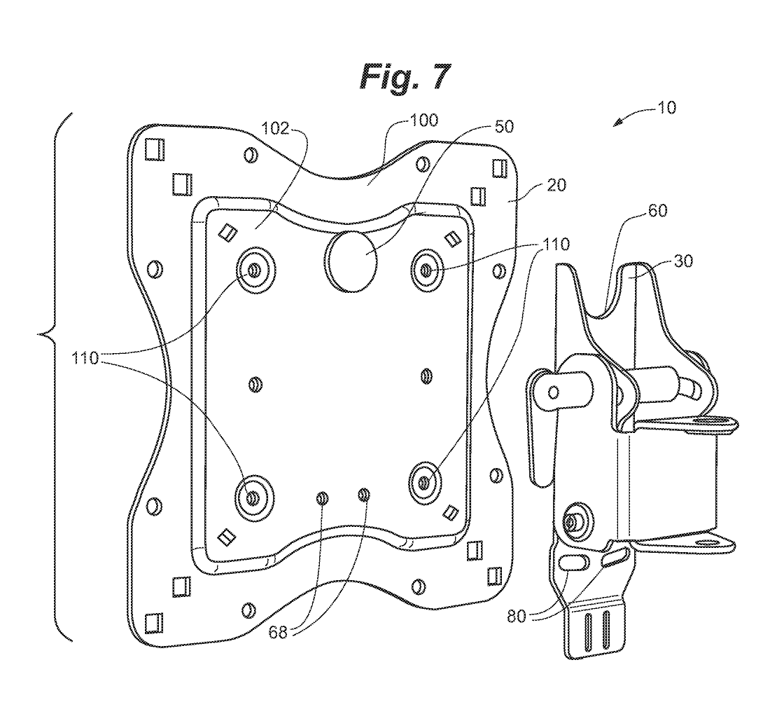

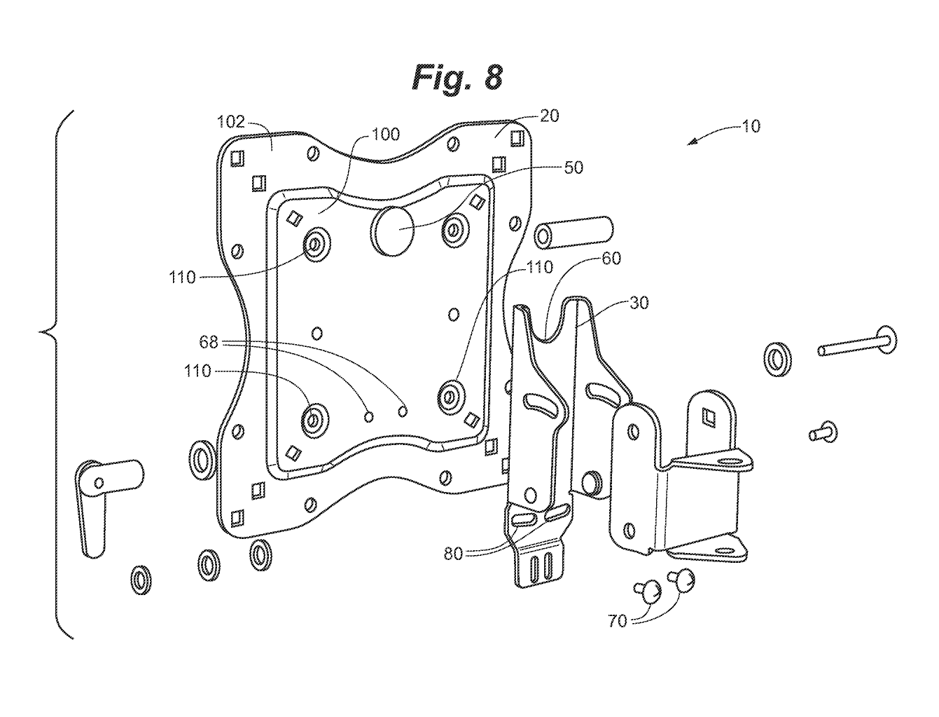

As shown in FIGS. 1-3, and 6, in some embodiments the display mounting bracket 20 includes a planar member 100 having a side adapted to be in apposition to a display. In such embodiments, the projection 50 can project outwardly from a plane defined by the planar member in a direction opposite a side adapted to be in apposition to the display. In certain embodiments, as shown in FIGS. 7 and 8, the display mounting bracket includes two planar members 100, 102 in apposition to each other, and at least one of the planar members includes an additional four apertures 110 for attaching the display mounting member to the display. In some embodiments, at least one of the planer members includes a Video Electronics Standards Association (VESA) complaint connection for connecting the display mounting bracket to the display. Accordingly, in such embodiments a first planar member (e.g., a VESA compliant plate) will be in apposition to, and connected with, the rear of the display, a second planar member will be in apposition to, and connected with, the first planar member, the first and second planar members comprising the display bracket, and the support bracket will be engaged with the second planar member of the display bracket, as described herein, and also connected to a support.

In addition to the groove to receive the projection, the support bracket 30 may also be provided with other features to allow greater degrees of freedom of movement of the display. For example, as shown best in FIGS. 2-3, some embodiments of the support bracket include a tilt mechanism 120 that allows a display to tilt relative to a support 40. Also as shown, the support bracket 30 can further include a pan mechanism 130 to allow the display to be panned relative to the support 40. In some embodiments, neither the support nor interface system allows for P/L adjustment, such that the interface system is the only mechanism that allows for angular adjustment about a generally horizontal axis generally normal to a display screen surface mounted via the interface system. In such embodiments, the interface system is braced against further P/L adjustment after it is fully connected to the display and support.

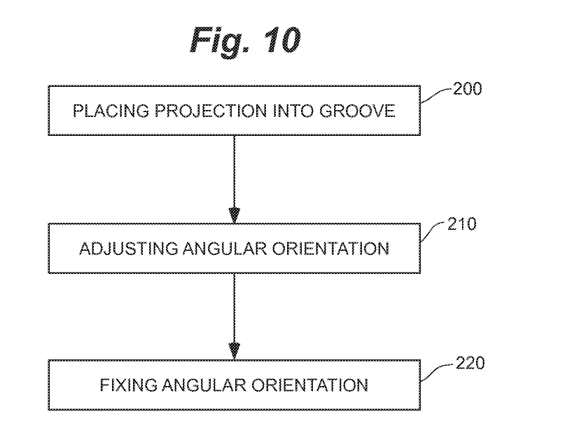

Embodiments of the invention also include a method of connecting an electronic display to a support using any embodiments of the interface system 10 described herein. A representative method is depicted in FIG. 10. A representative method includes placing a projection from a display mounting bracket into a groove provided by a support bracket 200, such as by inserting the projection into the groove, adjusting angular orientation 210 of the display mounting bracket with respect to the support bracket, such as by leveling a display connected to the display mounting bracket, (e.g., allowing the display to self-align), and fixing the adjusted angular orientation 220, such as by inserting a connector through a slot in the support bracket and an aperture in the display mounting bracket to fix an angular orientation of the display mounting bracket with respect to the display mounting bracket. In some embodiments, leveling includes placing the display in a horizontal orientation.

Some embodiments of the interface system are of a “quick connect” variety. In such embodiments, the display mounting bracket can be pre-attached to a display (e.g., via a first planar member VESA connection as described above) and the support bracket can be pre-attached to a support. A user can then simply insert the projection in to the groove and either actively adjust the angular orientation of the display relative to the support or let gravity self-align the display relative to the support. The user can then insert connectors through the slots and apertures to fix the angular P/L orientation of the display relative to the support.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

1. An interface system for connecting an electronic display to a support, the interface system comprising:
a display mounting bracket having a projection and an aperture for receiving a connector positioned below the projection; and
a support bracket having a groove to receive the projection and at least one slot for receiving the connector positioned below the groove, at least a portion of the slot being aligned with the aperture when the projection is engaged with the groove.

2. The interface system of claim 1, wherein the display mounting bracket includes two apertures.

3. The interface system of claim 2, wherein the support bracket includes two slots, at least a portion of each slot being aligned with at least one of the two apertures when the projection is engaged with the groove.

4. The interface system of claim 3, wherein the slot is curved to allow for a constant radius between a center of the slot and the projection as the angular orientation of the display mounting bracket is adjusted relative to the support bracket.

5. The interface system of claim 1, wherein the display mounting bracket includes a planar member having a side adapted to be in apposition to a rear of the electronic display.

6. The interface system of claim 5, wherein the display mounting bracket includes a first planar member having a side adapted to be in apposition to the rear of the electronic display, a second planar member in apposition to the first planar member, the second planar member including the projection.

7. The interface system of claim 1, wherein the projection projects outwardly from a plane defined by the planar member in a direction opposite the side adapted to be in apposition to the display.

8. The interface system of claim 1, wherein the projection includes a bolt generally cylindrical extending portion.

9. The interface system of claim 1, wherein the projection includes a lip to facilitate engagement with the groove.

10.-11. (canceled)

12. The interface system of claim 1, wherein the projection is substantially centered on the display mounting bracket.

13. The interface system of claim 1, wherein the connector is a screw.

14. The interface system of claim 1, wherein the support includes an arm.

15. The interface system of claim 1, wherein the interface system allows for between about 5 degrees and about 10 degrees of rotation relative to a generally horizontal axis extending through a rear of the electronic display.

16. A method of connecting an electronic display to a support, the method comprising:
placing a projection from a display mounting bracket into a groove provided by a support bracket;
leveling an electronic display connected to the electronic display mounting bracket; and
inserting a connector through a slot in the support bracket and an aperture in the display mounting bracket to fix an angular orientation of the display mounting bracket with respect to the support bracket.

17. The method of claim 16, wherein leveling includes placing the display in a horizontal orientation.

18. The method of claim 16, wherein the leveling step includes allowing the display to self-align, such that gravity provides the leveling function.

19. The method of claim 16, wherein in the leveling step includes rotating the display mounting bracket relative to the support bracket between about 5 degrees and about 10 degrees about a generally horizontal axis extending through a rear of the electronic display.
